(19) United States
(12) Patent Application Publication
(10) Pub. No.: US 2018/0278350 A1
(43) Pub. Date: Sep. 27, 2018

(54) RELAY APPARATUS, CONNECTION INFORMATION MANAGEMENT SYSTEM, AND NON-TRANSITORY COMPUTER READABLE MEDIUM

(71) Applicant: FUJI XEROX CO., LTD., Tokyo (JP)

(72) Inventors: Eiji NISHI, Kanagawa (JP); Keita SAKAKURA, Kanagawa (JP); Ryuichi ISHIZUKA, Kanagawa (JP); Chigusa NAKATA, Kanagawa (JP); Hiroshi HONDA, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP)

(73) Assignee: FUJI XEROX CO., LTD., Tokyo (JP)

(21) Appl. No.: 15/787,806

(22) Filed: Oct. 19, 2017

(30) Foreign Application Priority Data
Mar. 24, 2017 (JP) 2017-059242

(51) Int. Cl. H04B 17/40; H04W 8/30

(52) U.S. Cl. CPC H04B 17/40; H04W 88/04; H04W 8/30

(57) ABSTRACT

A relay apparatus includes a transmission/reception unit, a relay processing unit, a holding unit, an acquisition unit, and an inspection unit. The transmission/reception unit transmits and receives information via a network. The relay processing unit relays terminal information transmitted from a terminal apparatus via the transmission/reception unit, and transmits the terminal information to an information management apparatus that manages the terminal information which is acquired by the terminal apparatus. The holding unit holds the terminal information which is relayed by the relay processing unit. The acquisition unit acquires the terminal information which is managed by the information management apparatus. The inspection unit inspects, on the basis of the terminal information which is held by the holding unit and the terminal information which is acquired by the acquisition unit, whether the terminal information which is relayed by the relay processing unit has been received normally by the information management apparatus.

### CROSS-REFERENCE TO RELATED APPLICATIONS

This application is based on and claims priority under 35 USC 119 from Japanese Patent Application No. 2017-059242 filed Mar. 24, 2017.

### BACKGROUND

### Technical Field

The present invention relates to a relay apparatus, a connection information management system, and a non-transitory computer readable medium.

### Summary

According to an aspect of the present invention, there is provided a relay apparatus including: a transmission/reception unit that transmits and receives information via a network; a relay processing unit that relays terminal information transmitted from a terminal apparatus via the transmission/reception unit and that transmits the terminal information to an information management apparatus that manages the terminal information which is acquired by the terminal apparatus; a holding unit that holds the terminal information which is relayed by the relay processing unit; an acquisition unit that acquires the terminal information which is managed by the information management apparatus; and an inspection unit that inspects, on a basis of the terminal information which is held by the holding unit and the terminal information which is acquired by the acquisition unit, whether or not the terminal information which is relayed by the relay processing unit has been received normally by the information management apparatus.

### BRIEF DESCRIPTION OF THE DRAWINGS

An exemplary embodiment of the present invention will be described in detail based on the following figures, wherein:

FIG. 1 illustrates the overall configuration of a network system to which an exemplary embodiment is applied;

FIG. 2 illustrates the functional configuration of a relay apparatus according to the exemplary embodiment;

FIG. 3 is a sequence diagram illustrating how transmission and reception are performed among apparatuses of the network system illustrated in FIG. 1;

FIG. 4 is a flowchart illustrating operation of a terminal apparatus;

FIG. 5 is a flowchart illustrating operation of a terminal apparatus of a data management server;

FIG. 6 is a flowchart illustrating operation of the relay apparatus;

FIG. 7 is a flowchart illustrating operation of a connection information management server; and

FIG. 8 illustrates the configuration of an image processing apparatus that serves as the relay apparatus.

### DETAILED DESCRIPTION

An exemplary embodiment of the present invention will be described in detail below with reference to the accompanying drawings.

### System to which Exemplary Embodiment is Applied

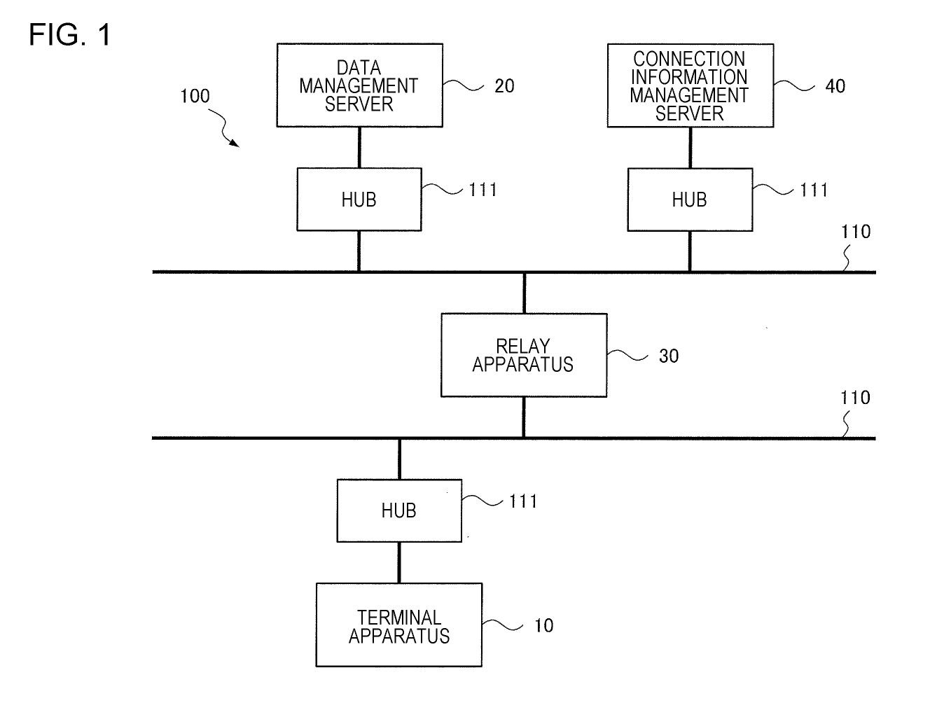

FIG. 1 illustrates the overall configuration of a network system 100 to which an exemplary embodiment is applied. As illustrated in FIG. 1, the network system 100 according to the exemplary embodiment includes a terminal apparatus 10, a data management server 20, a relay apparatus 30, and a connection information management server 40. The apparatuses are connected to each other via networks 110. In the exemplary embodiment, a connection information management system is constituted by the relay apparatus 30 and the connection information management server 40.

In the example illustrated in FIG. 1, the terminal apparatus 10, the data management server 20, and the connection information management server 40 are connected to each other via the networks 110 and the relay apparatus 30. The terminal apparatus 10, the data management server 20, and the connection information management server 40 are each connected to the network 110 via a hub 111. In the exemplary embodiment, as discussed in detail later, an apparatus that has an information processing function such as a gateway server is used as the relay apparatus 30. Thus, a simple hub or router is not used as the relay apparatus 30 according to the exemplary embodiment. It should be noted, however, that a router etc. that includes a central processing unit (CPU) and a memory and that is capable of executing information processing to be discussed later may be used as the relay apparatus 30 according to the exemplary embodiment. It is only necessary that the network system 100 to which the exemplary embodiment is applied should perform data (information) communication among the terminal apparatus 10 and the data management server 20 via the relay apparatus 30. The specific network configuration (relationship of connection among the apparatuses) is not limited to the configuration illustrated in FIG. 1. For example, the relay apparatus 30 may relay communication among plural terminal apparatuses 10 and plural data management servers 20, or plural relay apparatuses 30 may be connected to the connection information management server 40. The communication scheme which is used in the exemplary embodiment is not specifically limited. Examples include packet communication.

The networks 110 are not specifically limited as long as they are communication networks for use for data communication between apparatuses. Examples include the Internet, a local area network (LAN), and a wide area network (WAN). The communication line which is used for data communication between the apparatuses may be wired or wireless. The apparatuses may be connected to each other via plural networks and communication lines.

The terminal apparatuses 10 exchange data with other apparatuses via the network 110. The terminal apparatuses 10 in the exemplary embodiment may be applied to a variety of apparatuses that are connectable to the network 110 (i.e. that include a network interface for connection to the network 110). Specifically, the terminal apparatuses 10 according to the exemplary embodiment may be personal computers, portable information terminals, etc., for example. The terminal apparatuses 10 themselves may not perform information processing. For example, the terminal apparatuses 10 according to the exemplary embodiment may be apparatuses (sensor devices) etc. that measure information on the surrounding environment (such as temperature, humidity, and illuminance) using various sensors and that transmit obtained data to a server. Alternatively, the terminal apparatuses 10 according to the exemplary embodiment may be electronic devices etc. that include a mechanism that operates upon receiving a command from a server or another control apparatus on the network 110. Further, the terminal apparatuses 10 according to the exemplary embodiment may be servers (excluding the data management server 20 and the connection information management server 40 according to the exemplary embodiment) themselves that acquire data from such various information processing apparatuses and electronic devices or that provide a service.

The data management server 20 is an information management apparatus connected to the network 110 to manage the terminal apparatus 10, and receives data transmitted from the terminal apparatus 10 via the relay apparatus 30 and holds the data. The data management server 20 may be a local server built on a LAN, or may be a so-called cloud server built on the Internet. The data which are received by the data management server 20 are registered in and managed by a management part such as a database together with supplementary information such as the time of reception for each terminal apparatus 10 that transmitted the data, for example.

The relay apparatus 30 is provided on the network 110, and relays communication between the terminal apparatuses 10, communication between the terminal apparatus 10 and the data management server 20, and communication between the terminal apparatus 10 and the connection information management server 40. As discussed above, the relay apparatus 30 according to the exemplary embodiment may be an apparatus that has an information processing function such as a gateway server. Alternatively, the relay apparatus 30 according to the exemplary embodiment may be an electronic device that is connectable to the network 110 and that has an information processing function and a relay function. For example, an image processing apparatus such as a copier installed in an office etc. may be provided with a relay function and, used as the relay apparatus 30 for plural terminal apparatuses 10 in the room.

The connection information management server (connection information management apparatus) 40 is connected to the network 110, and receives from the relay apparatus 30 and holds the error detection result and the error information. The connection information management server 40 may be a local server built on a LAN, or may be a so-called cloud server built on the Internet. Only one relay apparatus 30 is illustrated in FIG. 1. However, the connection information management server 40 may be connected to plural relay apparatuses 30 to manage the error detection result and error information for the relay apparatuses 30.

The information which is held by the connection information management server 40 includes at least information for specifying the terminal apparatus 10 as the transmission origin and the terminal apparatus 10 as the transmission destination for the communication in which an error has occurred, and information on the time when the communication was performed. The information includes not only information simply indicating that an error has occurred in communication between specific individuals of the terminal apparatuses 10, but also information for use to determine the connectivity for a case where apparatuses of the same type are connected to the network 110 to perform communication. For example, the connection information management server 40 correlates information such as the individuality, the model, the vendor (manufacturer), etc. of the individual terminal apparatuses 10 and information such as a combination of the transmission origin and the transmission destination, the type of the communication service, the type of the error, the time and date when the error occurred, etc., and manages such information. The information which is held by the connection information management server 40 is used by the manufacturer etc. of a network device that serves as the terminal apparatus 10, for example, to evaluate the connectivity according to the model or the type of the communication service. Such information may be open to public so that a user may reference the information in the case where the user introduces the network device.

<Functional Configuration of Relay Apparatus>

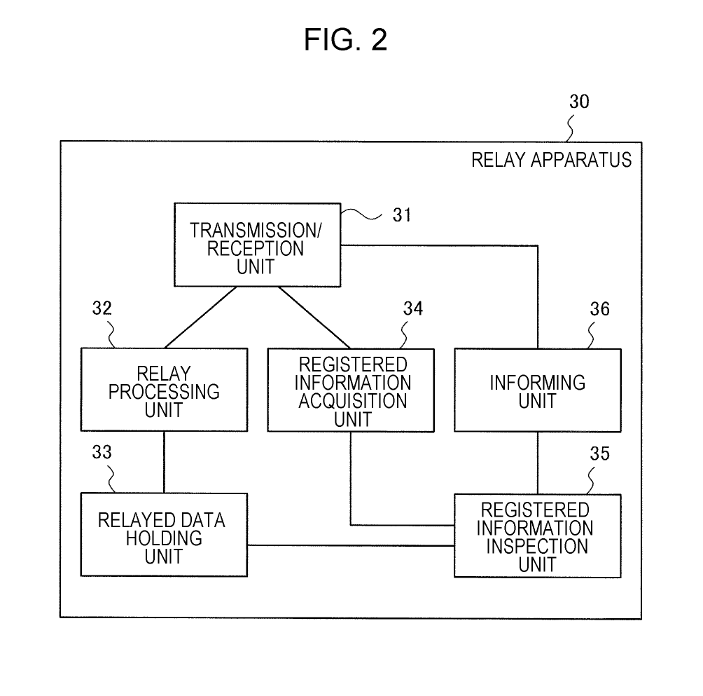

FIG. 2 illustrates the functional configuration of the relay apparatus 30 according to the exemplary embodiment. As illustrated in FIG. 2, the relay apparatus 30 according to the exemplary embodiment includes a transmission/reception unit 31, a relay processing unit 32, a relayed data holding unit 33, a registered information acquisition unit 34, a registered information inspection unit 35, and an informing unit 36. The transmission/reception unit 31 has a network interface for connection to the network 110, and transmits and receives a packet (data) to and from the terminal apparatus 10, the data management server 20, the connection information management server 40, etc. via the network 110.

The relay processing unit 32 relays a packet received from the terminal apparatus 10, and transmits the packet to the data management server 20 which is set as the transmission destination (address). Thus, the relay processing unit 32 has a function of analyzing the received packet and extracting information on the transmission destination, that is, a Media Access Control (MAC) address or an Internet Protocol (IP) address, for example. The relayed data holding unit 33 holds data (relayed data) relayed by the relay processing unit 32 and additional information such as identification information on the terminal apparatus 10 which transmitted the relayed data and the time when the relayed data were relayed (transmitted to the data management server 20).

The registered information acquisition unit 34 acquires registered information from the data management server 20 as the transmission destination after communication is relayed by the relay processing unit 32. The registered information is management information such as data transmitted from the terminal apparatus 10 registered in a management part of the data management server 20. As discussed above, the data management server 20 registers the received data in the management part such as a database, and manages the data. Thus, if the data which were transmitted from the terminal apparatus 10 have been received normally by the data management server 20, the received data have been registered as the registered information in the management part. The registered information acquisition unit 34 acquires the registered information which is based on the data which have been received normally by the data management server 20.

A condition for the registered information acquisition unit 34 to acquire the registered information may be set individually in accordance with the type, the specifications, the purpose of use, etc. of the terminal apparatus 10 and the data management server 20. For example, the registered information may be acquired within a predetermined period after data are relayed (transmitted) by the relay processing unit 32, or may be acquired regularly at predetermined intervals. Alternatively, the registered information may be acquired each time data are relayed (transmitted) a predetermined number of times to the data management server 20, or may be acquired each time data transmitted from a specific terminal apparatus 10 are relayed a predetermined number of times. The registered information may be acquired together with the last predetermined number of pieces of registered information acquired in the past. In this case, for example, pieces of data received by the data management server 20 in the last predetermined number of receptions are acquired as the registered information. Alternatively, the registered information acquisition unit 34 may acquire, together with the registered information, communication information such as the time when the data were received by the data management server 20, the time when the data were registered in the management part, and identification information for specifying the terminal apparatus 10 or the relay apparatus 30 as the transmission origin for the data.

The registered information inspection unit 35 contrasts the registered information which is acquired by the registered information acquisition unit 34 and the relayed data which is held by the relayed data holding unit 33, and inspects whether or not the relayed (transmitted) data have been registered normally. For example, the registered information inspection unit 35 determines that the relayed (transmitted) data have not been registered normally in the case where there is no registered information corresponding to the relayed data or in the case where a disagreement in content is found in the registered information corresponding to the relayed data. In the case where the communication information described above is acquired together with the registered information, for example, a search for the registered information corresponding to the relayed data is made on the basis of the time when the data management server 20 received the data, the terminal apparatus 10 which transmitted the data, etc. which are specified in accordance with the communication information. In the case where the registered information is acquired immediately after data are relayed (transmitted) by the relay apparatus 30, the last relayed (transmitted) data and the registered information that was registered last may be contrasted with each other. In this case, in the case where the last predetermined number of pieces of registered information have been acquired together, the registered information inspection unit 35 may inspect how many pieces of the last relayed data have been registered normally.

The informing unit 36 transmits error information to the connection information management server 40 via the transmission/reception unit 31 and informs the connection information management server 40 of the error information in the case where relayed data that have not been registered normally are detected by the registered information inspection unit 35. The error information may include not only information indicating that an error in communication is simply detected, but also information used to determine, on the basis of error detection, the connectivity (whether or not an error occurs in communication) for a case where apparatuses of the same type are connected to the network 110 to perform communication. For example, the error information may include individual identification information, product identification information, vendor (manufacturer) identification information, etc. By way of example, the error information includes a MAC address of the terminal apparatus 10. The MAC address is a physical address uniquely assigned to the hardware of a network device, and a 48-bit (EUI-48) code. The MAC address is normally expressed as six sets of octets (8-bit values). Of the six octets of the MAC address, in general, the first three octets represent a vendor (manufacturer) ID, the next one octet represents a model ID, and the last two octets represent a serial ID. Thus, the vendor, the model, and the individuality of the terminal apparatus 10 may be identified by analyzing the MAC address. A consideration is given to a case where the communication protocol which is used for communication from the terminal apparatus 10 is the HyperText Transfer Protocol (HTTP), the terminal apparatus 10 is an HTTP client, and the data management server 20 is an HTTP server. In this case, the error information may include information in the User-Agent field of the HTTP header, and the model of the terminal apparatus 10 may be identified using this information.

<Operation of Apparatuses>

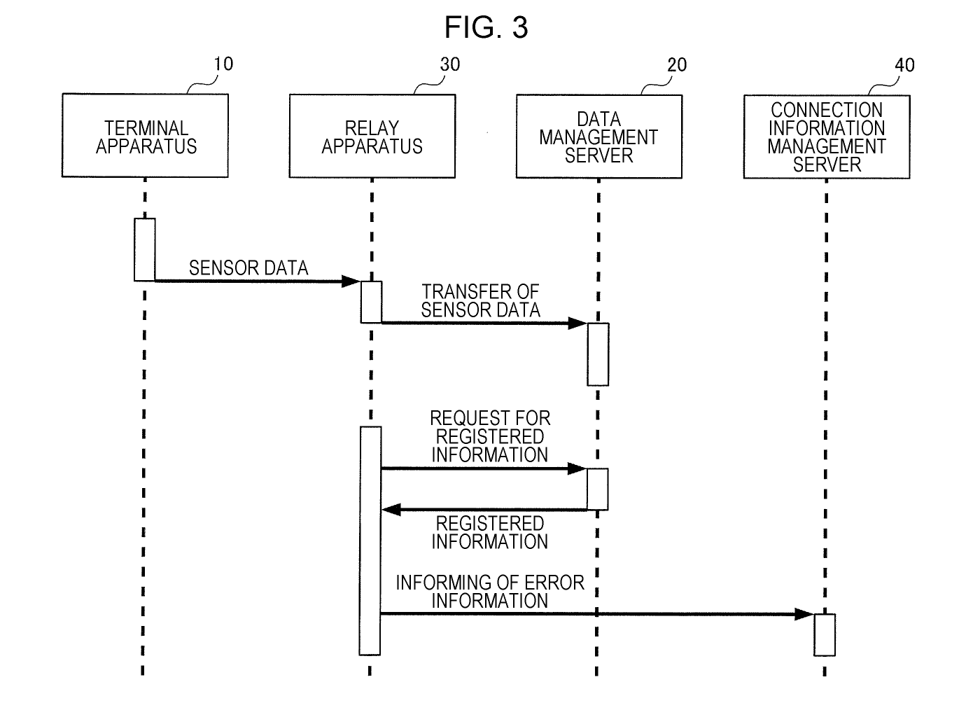

FIG. 3 is a sequence diagram illustrating how transmission and reception are performed among the apparatuses of the network system 100 illustrated in FIG. 1. In the example illustrated in FIG. 3, the terminal apparatus is a sensor device, and regularly transmits data (sensor data) as terminal information obtained using a sensor. As illustrated in FIG. 3, first, when a condition for transmission of the sensor data is met for the terminal apparatus 10, the sensor data are transmitted from the terminal apparatus 10. The sensor data which are transmitted from the terminal apparatus 10 are sent to the data management server 20 by way of the relay apparatus 30. The sensor data are also held by the relay apparatus 30. The data management server 20 registers the received sensor data in a database, and manages the sensor data. In the case where request data (request packet) that request a response from the data management server 20 are transmitted from the terminal apparatus 10, a response (response packet) to the request data is returned from the data management server 20 to the terminal apparatus 10, although not specifically illustrated. The response data are sent to the terminal apparatus 10 by way of the relay apparatus 30.

Next, when the condition for acquiring the registered information is met, the relay apparatus 30 requests the data management server 20 for the registered information. The data management server 20 returns the corresponding registered information in response to the request from the relay apparatus 30. In this event, the data management server 20 may return additional information such as identification information on the terminal apparatus 10 and the time of reception of the sensor data, together with the registered information, in accordance with a predetermined setting. The last plural pieces of registered information may be returned together.

The relay apparatus 30 contrasts the registered information etc. which is acquired from the data management server 20 and the sensor data which are saved with each other, and inspects whether or not the sensor data have been registered normally in the data management server 20. In the case where the sensor data have not been registered normally, the relay apparatus 30 transmits error information to the connection information management server 40, and informs the connection information management server 40 that the sensor data have not been registered normally.

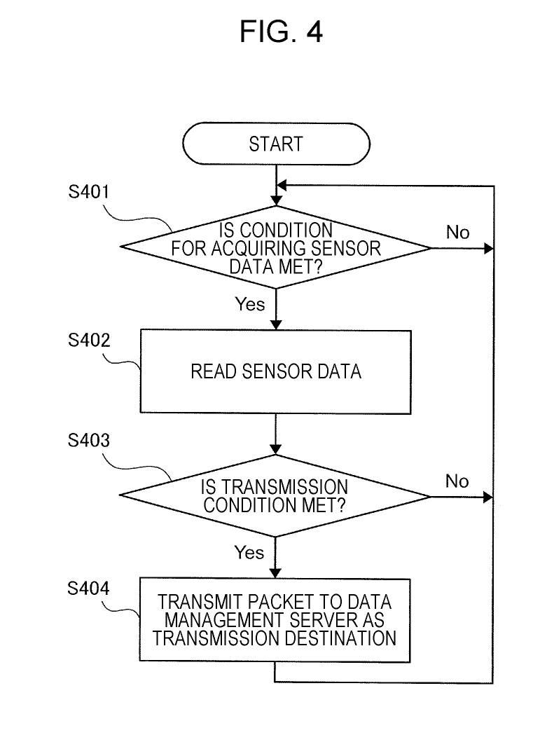

FIG. 4 is a flowchart illustrating operation of the terminal apparatus 10. As illustrated in FIG. 4, when the condition for acquiring the sensor data is met (S401), the terminal apparatus 10 reads the value of the sensor (S402). The condition for acquiring the sensor data is set in accordance with the content of data acquired by the terminal apparatus 10, the specifications of the terminal apparatus 10 itself, etc. A temporal condition may be set as the acquisition condition in order to regularly acquire data to be acquired or acquire data at a fixed time, for example. A fact that the sensor data have come to have a present content, such as a case where the ambient temperature has reached a preset threshold, may be used as the acquisition condition.

Next, when the condition for transmitting the sensor data is met (S403), the terminal apparatus 10 transmits a packet including the sensor data which are acquired in S402 to the data management server 20 (S404). The transmission condition is set in accordance with the content of data acquired by the terminal apparatus 10, the specifications of the terminal apparatus 10 and the data management server 20, etc. For example, establishment of connection between the terminal apparatus 10 and the data management server 20, the data management server 20 permitting transmission, etc. may be set as the transmission condition.

In the case where the condition for transmission to the data management server 20 is not met (No in S403), and after the data are transmitted to the data management server 20 in S404, the terminal apparatus 10 returns to S401, and stands by for the condition for acquiring the sensor data to be met. In the case where the transmission condition is not met (No in S403), the terminal apparatus 10 may stand by for the transmission condition to be met, rather than returning to S401, depending on the content of data acquired by the terminal apparatus 10, the specifications of the terminal apparatus 10 and the data management server 20, etc. In this case, the terminal apparatus 10 holds the data which are acquired in S402, and transmits a packet of the held data to the data management server 20 if the transmission condition is met.

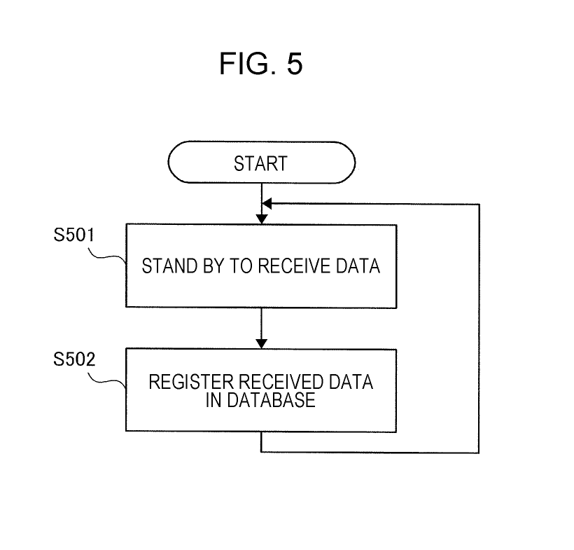

FIG. 5 is a flowchart illustrating operation of the data management server 20. As illustrated in FIG. 5, in a normal state, the data management server 20 stands by to receive data from the terminal apparatus 10 at all times (S501). Some communication condition may be provided for the data management server 20 to stand by for reception. In this case, the transmission condition is set in accordance with the content of data acquired by the terminal apparatus 10, the specifications of the terminal apparatus 10 and the data management server 20, etc. For example, setting may be made so as to receive data only at a preset time, or receive data from a specific terminal apparatus 10 only after data are received from another specific terminal apparatus 10.

When data are sent from the terminal apparatus 10 when the data management server 20 is standing by for reception, the data management server 20 receives the data, registers the received data in a database, and manages the data (S502). Then, the data management server 20 stands by for reception again.

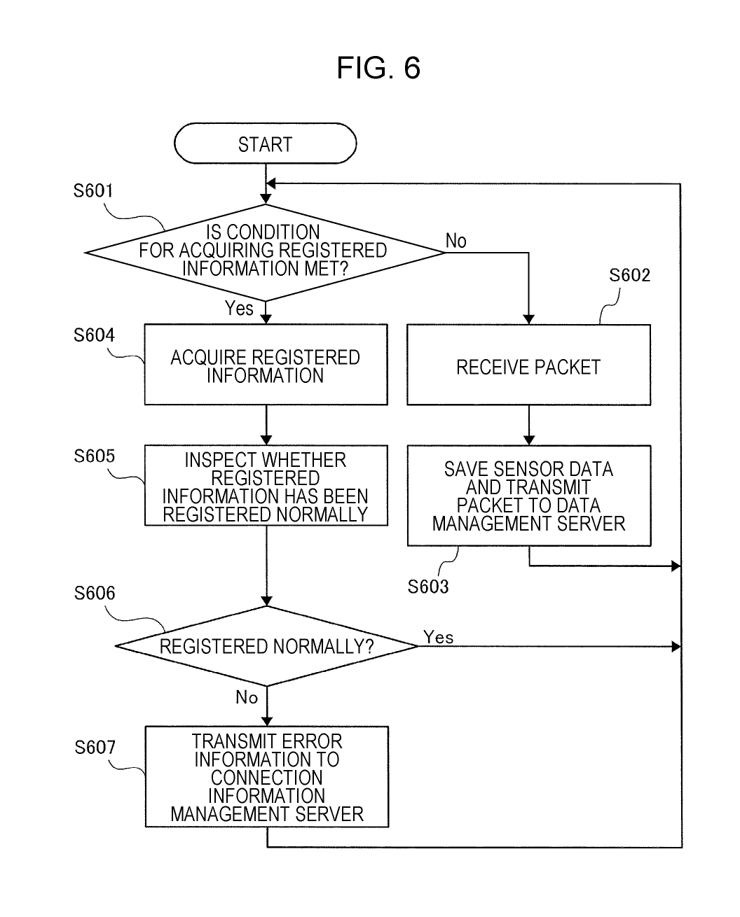

FIG. 6 is a flowchart illustrating operation of the relay apparatus 30. As illustrated in FIG. 6, in a normal state in which the condition for acquiring the registered information is not met (No in S601), the relay apparatus 30 stands by to receive a packet to be relayed at all times (S602). When a packet to be relayed is received, the relay apparatus 30 saves the sensor data which are included in the received packet in the relayed data holding unit 33, transmits the packet to the data management server 20 (S603), and returns to stand by to receive a packet to be relayed.

When the condition for acquiring the registered information is met (Yes in S601), the relay apparatus 30 acquires the registered information from the data management server 20 (S604). The relay apparatus 30 contrasts the acquired registered information and the sensor data which are saved in S603, and inspects whether or not the sensor data have been registered normally (S605). If it is determined that the sensor data have been registered normally in the data management server 20 (Yes in S606), the relay apparatus 30 returns to stand by to receive a packet to be relayed.

In the case where it is determined that the sensor data have not been registered normally in the data management server 20 (No in S606), on the other hand, the relay apparatus 30 transmits error information to the connection information management server 40 (S607), and returns to stand by to receive a packet to be relayed.

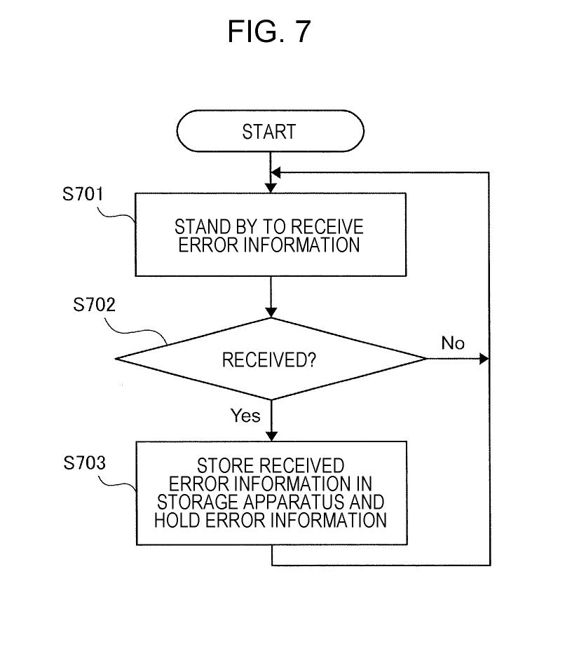

FIG. 7 is a flowchart illustrating operation of the connection information management server 40. As illustrated in FIG. 7, in a normal state, the connection information management server 40 stands by to receive error information from the relay apparatus 30 at all times (S701 and S702). When the error information is received from the relay apparatus 30, the connection information management server 40 stores the received error information in a storage apparatus such as a magnetic disk apparatus, and holds the error information (S703).

<Configuration of Image Processing Apparatus as Example of Relay Apparatus 30>

A variety of devices are used as the relay apparatus 30 according to the exemplary embodiment in accordance with the configuration of the networks 110. In the exemplary embodiment, a gateway server that has an information processing function of holding sensor data received from the terminal apparatus 10 and contrasting the sensor data with registered information acquired from the data management server 20, rather than a simple hub or router, is used as the relay apparatus 30. A configuration example for a case where an image processing apparatus that serves as a multi-function device that has a copying function, an image reading function, a printing function, etc. and that includes a network interface is used as the relay apparatus 30 will be described by way of example.

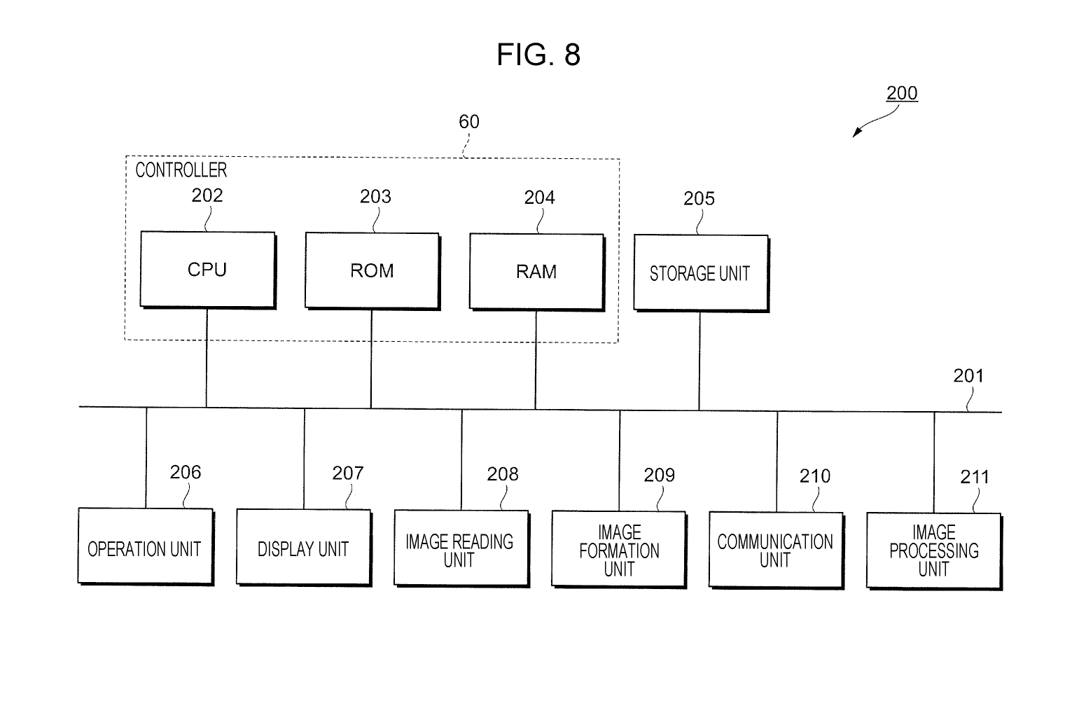

FIG. 8 illustrates the configuration of an image processing apparatus 200.

In the configuration illustrated in FIG. 8, the image processing apparatus 200 includes a CPU 202, a read only memory (ROM) 203, and a random access memory (RAM) 204 that constitute a controller 60. The image processing apparatus 200 also includes a storage unit 205, an operation unit 206, a display unit 207, an image reading unit 208, an image formation unit 209, a communication unit 210, and an image processing unit 211. These various functional units are connected to a bus 201, and exchange data with each other via the bus 201.

The operation unit 206 receives an operation by a user. The operation unit 206 is constituted of hardware keys, for example. Alternatively, the operation unit 206 is constituted of a touch sensor that outputs a control signal that matches a pressed position, for example. The operation unit 206 may be constituted as a touch screen that is a combination of the touch sensor and a liquid crystal display that constitutes the display unit 207 to be discussed later.

The display unit 207 is an example of a display part, and is constituted of a liquid crystal display, for example. Under control by the CPU 202, the display unit 207 displays information about the image processing apparatus 200. The display unit 207 displays a menu screen to be referenced by the user when the user operates the image processing apparatus 200. That is, the operation unit 206 described above and the display unit 207 are combined with each other to function as a user interface unit of the image processing apparatus 200.

The image reading unit 208 is constituted of a so-called scanner apparatus, and optically reads an image on a document set on the image reading unit 208 and generates a read image (image data). Examples of the image reading scheme include a CCD type in which light radiated from a light source and reflected by the document is contracted using a lens to be received by charge coupled devices (CCD) and a CIS type in which light sequentially radiated from a light emitting diode (LED) light source and reflected by the document is received by a contact image sensor (CIS).

The image formation unit 209 is an example of an image forming part, and forms an image based on image data using an image forming material on paper that is an example of a recording material. Examples of the scheme for forming an image on the recording material include an electrophotographic system in which toner adhering to a photosensitive body is transferred onto the recording material to form an image and an inkjet type in which ink is injected onto the recording material to form an image.

The communication unit 210 has a network interface that communicates with the terminal apparatus 10, the data management server 20, and the connection information management server 40 via the networks 110, and functions as the transmission/reception unit 31 of the relay apparatus 30. Although not described distinctively, in the case where the image processing apparatus 200 has a facsimile function, the communication unit 210 also has a function for connection to a telephone line for facsimile transmission and reception.

The image processing unit 211 includes a processor that serves as a computation part and a work memory, and performs image processing such as color correction and tone correction on an image represented by the image data. The CPU 202 of the controller 60 may also be used as the processor, and the RAM 204 of the controller 60 may also be used as the work memory.

The storage unit 205 is an example of the storage part, and is constituted of a storage apparatus such as a hard disk apparatus, for example. The storage unit 205 stores image data such as the read image which is generated by the image reading unit 208. The storage unit 205 functions as the relayed data holding unit 33 of the relay apparatus 30 illustrated in FIG. 2.

Among the CPU 202, the ROM 203, and the RAM 204 which constitute the controller 60, the ROM 203 stores a program to be executed by the CPU 202. The CPU 202 reads the program which is stored in the ROM 203, and executes the program using the RAM 204 as the work area. A program stored in the storage unit 205 may be read into the RAM 204, and the program which is read into the RAM 204 may be executed by the CPU 202.

The CPU 202 executes a program to control the various units of the image processing apparatus 200. In the exemplary embodiment, in particular, when the program is executed by the CPU 202, the function of the registered information inspection unit 35 of the relay apparatus 30 illustrated in FIG. 2 is implemented by the controller 60. The functions of the relay processing unit 32, the registered information acquisition unit 34, and the informing unit 36 illustrated in FIG. 2 are implemented by the controller 60 and the communication unit 210.

<Modifications>

In the exemplary embodiment described above, the relay apparatus 30, the data management server 20, and the connection information management server 40 are provided separately from each other, and connected to each other via the network 110. In contrast, the function of one or both of the data management server 20 and the connection information management server 40 may be implemented by the relay apparatus 30.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A relay apparatus comprising:
a transmission/reception unit that transmits and receives information via a network;
a relay processing unit that relays terminal information transmitted from a terminal apparatus via the transmission/reception unit and that transmits the terminal information to an information management apparatus that manages the terminal information which is acquired by the terminal apparatus;
a holding unit that holds the terminal information which is relayed by the relay processing unit;
an acquisition unit that acquires the terminal information which is managed by the information management apparatus; and
an inspection unit that inspects, on a basis of the terminal information which is held by the holding unit and the terminal information which is acquired by the acquisition unit, whether or not the terminal information which is relayed by the relay processing unit has been received normally by the information management apparatus.

2. The relay apparatus according to claim 1,
wherein the acquisition unit acquires the terminal information from the information management apparatus after a predetermined period elapses after the terminal information which is transmitted from the terminal apparatus is relayed.

3. The relay apparatus according to claim 1,
wherein the acquisition unit regularly acquires the terminal information from the information management apparatus.

4. The relay apparatus according to claim 1,
wherein the acquisition unit acquires the terminal information from the information management apparatus each time the terminal information is relayed a predetermined number of times.

5. The relay apparatus according to claim 1,
wherein the acquisition unit acquires the terminal information including pieces of the terminal information received by the information management apparatus in a last predetermined number of receptions.

6. A connection information management system comprising:
a relay apparatus that relays communication between a terminal apparatus and an information management apparatus performed via a network; and
a connection information management apparatus connected to the relay apparatus,
wherein the relay apparatus includes
a relay processing unit that relays terminal information transmitted from a terminal apparatus and that transmits the terminal information to the information management apparatus which manages the terminal information which is acquired by the terminal apparatus,
a holding unit that holds the terminal information which is relayed by the relay processing unit,
an acquisition unit that acquires the terminal information which is managed by the information management apparatus, and
an inspection unit that inspects, on a basis of the terminal information which is held by the holding unit and the terminal information which is acquired by the acquisition unit, whether or not the terminal information which is relayed by the relay processing unit has been received normally by the information management apparatus,
wherein the connection information management apparatus stores and manages results of inspections from a plurality of relay apparatuses.

7. A non-transitory computer readable medium storing a program causing a computer of a relay apparatus to execute a process for relaying communication performed via a network, the process comprising:
relaying terminal information transmitted from a terminal apparatus and transmitting the terminal information to an information management apparatus;
holding the terminal information, which is relayed in the relaying, in a storage part;
acquiring the terminal information which is managed by the information management apparatus; and
inspecting, on a basis of the terminal information which is held in the holding and the terminal information which is acquired in the acquiring, whether or not the terminal information which is relayed in the relaying has been received normally by the information management apparatus.
